(19) United States
(12) Patent Application Publication
(10) Pub. No.: US 2008/0049173 A1
(43) Pub. Date: Feb. 28, 2008

(54) Optical film, polarizing plate and liquid crystal display device

(75) Inventors: Akihiro Matsufuji, Minami-Ashigara-shi (JP); Hiroaki Sata, Minami-Ashigara-shi (JP); Takeichi Tatsuta, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/889,306

(22) Filed: Aug. 10, 2007

(30) Foreign Application Priority Data
Aug. 24, 2006 (JP) 2006-228036

(51) Int. Cl. G02B 5/22; G02B 5/30; G02F 1/1335

(52) U.S. Cl. 349/96; 428/1.3; 428/1.31

(57) ABSTRACT

An optical film includes a cellulose acylate, a polymer additive that decreases an optical anisotropy of the cellulose acylate, a compound that has a plasticizing effect, and a compound that changes a wavelength dispersion of an optical property of the cellulose acylate.

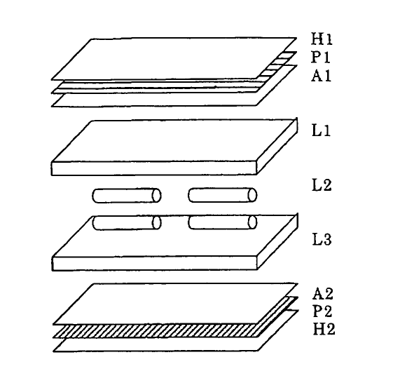

### BACKGROUND OF THE INVENTION

1. Field of the Invention

The present invention relates to an optical film, and a polarizing plate and a liquid crystal display device each using the optical film.

2. Description of the Related Art

A cellulose acylate film, typically, a cellulose triacetate film, is being used as a protective film of a polarizing plate in a liquid crystal display device because of its mechanical property, transparency and optical isotropy, that is, low optical anisotropy. Also, the cellulose acylate film is utilized as a support of an optically-compensatory film such as WV film (Wide-View Film, a viewing angle-enlarging film) released from Fuji Photo Film Co., Ltd. or as a support of an antireflection film (for example, CV Film produced by Fuji Photo Film Co., Ltd.) for liquid crystal televisions which are energy-saving, lightweight and non-space-consuming and therefore, are increasingly introduced to the market at present in place of CRT.

The liquid crystal display device comprises a liquid crystal cell, a polarizing plate and the like. The polarizing plate is composed of a protective film, a polarizing film and the like and obtained, for example, by dyeing a polarizing film comprising a polyvinyl alcohol film with iodine, stretching the film and stacking a protective film on both surfaces thereof. In a transmission-type liquid crystal display device, the polarizing plate is fixed on both sides of the liquid crystal cell and one or more optically-compensatory sheets are sometimes further disposed thereon. In a reflection-type liquid crystal display device, a reflector plate, a liquid crystal cell, an optically-compensatory sheet and a polarizing plate are disposed in this order. The liquid crystal cell comprises a liquid crystalline molecule, two substrates for sealing-in the liquid crystalline molecule, and an electrode for applying a voltage to the liquid crystalline molecule. The liquid crystal cell effects the ON-OFF display by utilizing the aligned state of liquid crystal molecules, and there have been proposed various display modes applicable to both the transmission type and the reflection type, such as TN (twisted nematic), IPS (in-plane switching), OCB (optically compensatory bend), VA (vertically aligned) and ECB (electrically controlled birefringence).

The optically-compensatory film is used in various liquid crystal display devices for canceling the image coloration or enlarging the viewing angle. As for the optically-compensatory film, a stretched birefringent polymer film has been conventionally used. Recently, in place of the optically-compensatory sheet comprising a stretched birefringent film, an optically-compensatory film having an optically anisotropic layer formed from low-molecular or polymer liquid crystalline molecules on a transparent support with low optical anisotropy, such as cellulose triacetate film, is often used. The liquid crystalline molecules can align in various modes and therefore, optical properties unobtainable from a conventional birefringent polymer film can be realized by using a liquid crystalline molecule.

The optical property of the optically-compensatory film is determined according to the optical property, specifically, difference in the display mode, of the liquid crystal cell. When a liquid crystalline molecular is used, an optically-compensatory film having various optical properties corresponding to various display modes of the liquid crystal cell can be produced. As for the optically-compensatory film using a liquid crystalline molecule, those corresponding to various display modes have been proposed.

For example, the optically-compensatory film for a TN-mode liquid crystal cell, when applied with a voltage, effects optical compensation of a tilt aligned state on the substrate plane while canceling the twisted structure of liquid crystal molecules and prevents light leakage in the oblique direction at the black display time to thereby improve the viewing angle property of contract (see, JP-A-6-214116 (the term “JP-A” as used herein means an “unexamined published Japanese patent application”)). The optically-compensatory film for an IPS-mode liquid crystal cell effects, at the black display time in a non-voltage-applied state, both optical compensation of the liquid crystal molecules aligned in parallel to the substrate plane and enhancement of the viewing angle property of cross transmittance of the polarizing pate (see, JP-A-10-54982). The optically-compensatory film for an OCB-mode liquid crystal cell, when applied with a voltage, effects optical compensation of a liquid crystal layer oriented in vertical alignment at the center of the liquid crystal layer and in tilt alignment near the interface with the substrate and thereby improves the viewing angle property of black display (see, U.S. Pat. No. 5,805,253). The optically-compensatory film for a VA-mode liquid crystal cell improves the viewing angle property of black display in a non-voltage-applied state where liquid crystal molecules are aligned vertically to the substrate plane (see, Japanese Patent 2,866,372).

The optimal optically-compensatory film varies according to the display mode of the liquid crystal cell or the specific design of the liquid crystal cell and although various specifications are being studied and produced, when a cellulose acylate film is used as the support and a low molecular or polymer liquid crystal is provided and aligned on the support, there are a case where an optically compensating function is preferably imparted also to the cellulose acylate film, and a case where an optically compensating function is preferably imparted only to a low molecular or polymer liquid crystal layer. In the latter case, the cellulose acylate film preferably has no optical anisotropy.

In general, the presence of optical anisotropy in a polymer resin material is widely known, including causes thereof, and also for realizing low optical anisotropy, various methods have been proposed as follows.

(1) A method of blending two kinds of polymer resins having alignment birefringence (optical anisotropy) with opposite signs to each other and being completely compatible (see, U.S. Pat. No. 4,373,065).

(2) A method of mixing an aromatic Pc and a specific St-based copolymer (see, JP-A-61-19656).

(3) A method of random-copolymerizing, graft-copolymerizing or block-copolymerizing positive/negative monomers having a main polarizability difference of 50×10⁻²⁵ or more in terms of absolute value (see, JP-A-61-108617).

(4) A mixture or block copolymer of a polymer mainly comprising an aromatic vinyl monomer with a polyphenylene ether, or a mixture thereof (see, JP-A-62-240901).

(5) A copolymer composition of MMA and 3FMA (trifluoroethyl methacrylate), or MMA and BzMA (benzyl methacrylate) (see, Journal, Kogaku (Optics), 1991.2).

(6) A method of adding a low molecular substance which exhibits optical anisotropy having a tendency to decrease the optical anisotropy of a polymer resin material, to the polymer resin matrix (see, JP-A-8-110402).

(7) An optical resin material containing a polymer resin and a fine inorganic substance which orients in the same direction as the orientation direction of the bond chain of the polymer resin, wherein the optical anisotropy of the oriented polymer resin is decreased by the optical anisotropy of the inorganic substance (see, JP-A-11-293116).

(8) A method of mixing a particle for the compensation of optical anisotropy, which is smaller than the wavelength of light, into a polymer resin, wherein the particle for the compensation of optical anisotropy is an isotropic polarization or isotropic shape particle (see, JP-A-2000-313816).

In the method of (1), complete compatibilization of the polymer resins is difficult and the visible light is scattered due to difference in the refractive index between two kinds of polymers, causing whitening of the film. The methods (2) to (5) are restricted in the selection of material and have a problem that whether the birefringence is satisfactorily canceled or whether the mechanical properties such as brittleness are sufficient is not known until the synthesis is performed. Furthermore, the cost becomes very high to make industrial implementation extremely difficult. In the method of (6), the effect of decreasing the optical anisotropy is not sufficiently high and the organic substance must be added in a large amount, giving rise to problems such as bleed-out and whitening. In the methods of (7) and (8), the particles added are aggregated and the film becomes white due to scattering considered to be ascribable to the difference in the refractive index between the aggregate and the matrix.

That is, the above-described methods each has a certain level of effect, but the effect is still insufficient, and those materials cannot be widely used as a polarizing plate material for liquid crystal displays particularly in that the characteristic feature as a transparent film is lost or the industrial implementation is not viable.

In order to solve these problems, a cellulose acylate film with low optical anisotropy, in which an organic substance exhibiting optical anisotropy having a tendency to cancel the optical anisotropy of a cellulose acylate film is added, has been developed (JP-A-2005-105140), but the wavelength-dependency of optical property is high or when the amount of the polymer added is increased to decrease the optical anisotropy, there arises a problem that the flexibility is impaired, cracks are generated at the cutting, or haze becomes large due to insufficient compatibility.

As for the plasticizer which decreases the optical anisotropy, (di)pentaerythritol esters (JP-A-11-124445), glycerol esters (JP-A-11-246704), diglycerol esters (JP-A-2000-63560), citric esters (JP-A-11-92574) and substituted phenylphosphoric esters (JP-A-11-90946) have been proposed, but the desired sufficiently small Rth value cannot be obtained only by such a plasticizer.

### SUMMARY OF THE INVENTION

The present invention has been made by taking into account the problems above and an object of the present invention is to industrially and inexpensively provide an optical film with low optical anisotropy, which is transparent and used as a polarizing plate material for liquid crystal displays, not by a method incurring poor transparency or restriction in the production as in those various conventional methods. More specifically, the object of the present invention is to provide a protective film for polarizing plates or a support for optically-compensatory films, ensuring that the optical anisotropy of a cellulose acylate film having excellent properties as a polarizing plate material for liquid crystal displays and being representative of an inexpensive transparent polymer film is almost completely canceled, the handling is good, the display quality such as viewing angle and tint change of a liquid crystal display is remarkably improved, and the compatibility and in turn the transparency are enhanced.

The object of the present invention is attained by the following [1] to [9].

[1] An optical film comprising:

a cellulose acylate;

a polymer additive that decreases an optical anisotropy of the cellulose acylate;

a compound that has a plasticizing effect; and

a compound that changes a wavelength dispersion of an optical property of the cellulose acylate.

[2] The optical film as described in [1],

wherein the polymer additives has an average molecular weight of 3,000 or more, and

the compound having the plasticizing effect has a molecular weight of 3,000 or less.

[3] The optical film as described in [1],

wherein the compound changing the wavelength dispersion of the optical property is a compound that absorbs a light in the ultraviolet region.

[4] The optical film as described in [1],

wherein an acyl group of the cellulose acylate has from 2 to 4 carbon atoms, and

a total substitution degree of the cellulose acylate is from 2.7 to 3.0.

[5] The optical film as described in [1], having a glass transition temperature of from 100° C. to less than 160° C.

[6] The optical film as described in [1], having Re(630) of 0 to 20 nm and Rth(630) of from −20 to 10 nm,

wherein Re(630) represents an in-plane retardation at a wavelength of 630 nm, and

Rth(630) represents a retardation in a thickness direction at a wavelength of 630 nm.

[7] The optical film as described in [1], satisfying the following formula (3):

|Rth(700)−Rth(400)|≦25 nm Formula (3)

wherein Rth(700) and Rth(400) represent retardations in a thickness direction at a wavelength of 700 nm and 400 nm, respectively.

[8] A polarizing plate comprising:

a polarizer; and

the optical film as described in [1], which is provided on at least one side of the polarizer.

[9] A liquid crystal display device comprising:

the polarizing plate as described in [8].

### BRIEF DESCRIPTION OF THE DRAWING

The Drawing is a schematic view schematically showing a preferred embodiment of the liquid crystal display device of the present invention,

wherein H1 and H2 denote Protective films, P1 and P2 denote Polarizers, A1 and A2 denote Protective films, L1 denotes Phase difference film A, L2 denotes Liquid crystal layer and L3 denotes Phase difference film B.

### DETAILED DESCRIPTION OF THE INVENTION

### [Polymer Additive Which Decreases Optical Anisotropy]

In the present invention, the polymer additive which exhibits optical anisotropy having a tendency to decrease the optical anisotropy of a cellulose acylate indicates a compound which decreases the optical anisotropy developed by a cellulose acylate, that is, which orients in parallel to the cellobiose skeleton and has a large refractive index in the direction perpendicular to its own molecular axis. The polymer additive is not particularly limited as long as it has such properties, but a polymer having high affinity for a cellulose acylate and having a negative intrinsic birefringence is preferred. Preferred examples of the polymer include a styrene-based polymer, an acrylic acid-based polymer, a methacrylic acid-based polymer, an acrylonitrile-based polymer and a methacrylonitrile-based polymer, and a copolymer thereof is also preferred. Examples of the acrylic acid-based polymer and methacrylic acid-based polymer include polymers of a methyl, ethyl, phenyl or benzyl ester of acrylic acid or methacrylic acid. An acrylic acid-based polymer and a methacrylic acid-based polymer are close in the refractive index value to a cellulose acylate and are preferred.

The average molecular weight of this polymer is preferably 3,000 or more, more preferably 5,000 or more, and for avoiding bleed-out, preferably 20,000 or less, more preferably 10,000 or less. Here, the average molecular weight is a polystyrene-reduced mass average molecular weight determined by GPC.

A polymer having a molecular weight in the above-described range can be obtained by polymerization in a high chain-transferable solvent such as toluene and IPA, polymerization in the presence of a chain transfer agent such as thiol (e.g., β-mercaptopropionic acid, thioglycerin), polymerization in a state of the monomer/polymerization initiator ratio being small, or polymerization under the combined condition thereof.

The amount of the polymer added is preferably from 5 to 30 parts by mass, more preferably from 10 to 25 parts by mass, per 100 parts by mass of cellulose acylate.

### [Plasticizer]

The compound having a plasticizing effect, which is used in the present invention, is preferably a compound having a functional group, such as phosphoric acid ester, carboxylic acid ester, amide, ether and urethane.

Examples of the phosphoric acid ester include triphenyl phosphate, biphenyl diphenyl phosphate, tricresyl phosphate, cresyl diphenyl phosphate, octyl diphenyl phosphate, trioctyl phosphate, tributyl phosphate, resorcinol bis-diphenyl phosphate, 1,3-phenylene bis-dixylenyl phosphate and bisphenol A bis-diphenyl phosphate.

Examples of the carboxylic acid ester include a carboxylic acid ester of polyhydric alcohol, such as trimethylolpropane tribenzoate, trimethylolpropane tricyclohexyl carboxylate, pentaerythritol tetrabutylate, glycerin tributylate, triacetin, tributyrin and tripropionin; a saturated or unsaturated polyvalent carboxylic acid ester such as dibutyl succinate, diphenyl adipate, dibutyl phthalate, diaryl phthalate, dimethyl phthalate, diethyl phthalate, di-2-methoxyethyl phthalate, dioctyl phthalate, di-2-ethylhexyl phthalate, trimethyl trimellitate and tetraethyl pyromellitate; and an oligomer of methyl methacrylate or ethyl acrylate.

Examples of the ester of hydroxy acid include an ester of a hydroxy acid such as glycolic acid, salicylic acid, citric acid, malic acid and tartaric acid, e.g., triethyl citrate, acetyl triethyl citrate, dibutyl tartrate, dibutyl diacetyltartrate, butylphthalyl butyl glycolate, ethylphthalyl ethyl glycolate, methylphthalyl ethyl glycolate, butylphthalyl butyl glycolate.

Examples of the amide include a carboxylic acid amide and a sulfonic acid amide, such as N-phenyl-benzenecarbonamide, N-phenyl-p-toluenesulfonamide and N-ethyltoluenesulfonamide.

Other examples include a sulfonic acid ester such as o-cresyl p-toluenesulfonate; and a urethane by the reaction of toluene diisocyanate with an alcohol such as ethanol or hexyl alcohol.

A low molecular weight oligomer, for example, an ether oligomer such as glycidyl ether of bisphenol A, and a urethane oligomer by the reaction of toluene diisocyanate with a mixture of dihydric alcohol and monohydric alcohol, is also preferred.

Other preferred examples include a trityl alcohol.

The amount added of the compound exhibiting a plasticizing effect is preferably from 5 to 30 parts by mass, more preferably from 10 to 25 parts by mass, per 100 parts by mass of cellulose acylate.

The molecular weight of the compound having a plasticizing effect is preferably 3,000 or less, more preferably 2,000 or less. Also, the molecular weight is preferably 200 or more, because if the molecular weight is small, the vaporization amount at the drying under heating increases.

### [Wavelength-Dispersion Adjusting Agent]

The Rth of the film of the present invention can be made small, but the Rth of cellulose acylate varies depending on the wavelength and the value sometimes greatly differs between the long wavelength side and the short wavelength side. The Rth values at wavelengths of 400 nm and 700 nm are preferably in the relationship of the following formula (3).

|Rth(700)−Rth(400)|≦25 nm Formula (3)

The compound which changes the wavelength dispersion of the optical property is preferably a compound mainly comprising a benzotriazole, benzophenone, cyanoacrylate or triazine skeleton and may be substituted by various substituents. Preferred examples are set forth below, but the present invention is not limited thereto. In the following structural formulae, R represents an organic substituent and R′ represents H, OH or an organic substituent. Examples of the organic substituent include an alkyl group having a carbon number of 1 to 12, and an aryl group. Such a compound preferably has absorption in the ultraviolet region of 200 to 400 nm and preferably has no absorption in the visible region.

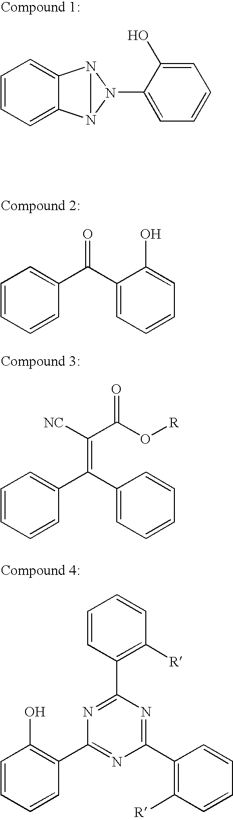

Examples of Compound 1 include 2-(2-hydroxy-5-tert-octylphenyl)-2H-benzotriazole, 2-(2-hydroxy-5-methylphenyl)-2H-benzotriazole, 2-(2-hydroxy-5-methylphenyl)-2H-benzotriazole, 2-(2-hydroxy-5-tert-butylphenyl)-2H-benzotriazole, 2-(2-hydroxy-3-tert-butyl-5-methylphenyl)-2H-benzotriazole, 2-(2-hydroxy-3,5-di-tert-butylphenyl)-2H-benzotriazole, 2-(2-hydroxy-3,5-di-tert-pentylphenyl)-2H-benzotriazole, 2-[2-hydroxy-3-(3,4,5,6-tetrahydrophthalamido-methyl)-5-methylphenyl]benzotriazole, a 3-(2H-benzotriazol-2-yl)-5-(1,1-dimethylethyl)-4-hydroxy C7-C9 side-chain linear alkyl ester with benzenepropanoic acid, and 2-(2-hydroxy-3,5-bis(1-methyl-1-phenylethyl)phenyl)-2H-benzotriazole.

Examples of Compound 2 include 2-hydroxy-4-n-hectoxybenzophenone, 2-hydroxy-4-n-octoxybenzophenone, 2-hydroxy-4-benzyloxybenzophenone, 2,2′-dihydroxy-4,4′-dimethoxybenzophenone and 2,2′-dihydroxy-4-methytoxybenzophenone.

Examples of Compound 3 include ethyl-2-cyano-3,3-diphenyl acrylate, (2-ethylhexyl)-2-cyano-3,3-diphenyl acrylate and decyl-2-cyano-3-(5-methoxy-phenyl)acrylate.

Examples of Compound 4 include 2,4-bis(2-hydroxy-4-butoxyphenyl)-6-(2,4-dibutoxyphenyl)-1,3,5-triazine, 2-(2,4-dihydroxyphenyl)-4,6-bis(2,4-dimethylphenyl)-1,3,5-triazine, 2-(2-hydroxy-4-butoxyphenyl)-4,6-diphenyl-1,3,5-triazine.

Examples of other compounds include a salicylic acid ester such as phenyl salicylate and tolyl salicylate, and an ester such as (2,4-di-tert-butyl)phenyl-(4-hydroxy-3,5-di-tert-butyl)benzoate.

A benzophenone-based compound and an ester-based compound are more preferred.

At least one kind of the compound which changes the wavelength dispersion of the optical property is contained in an amount of 0.1 to 30 mass %, preferably from 0.2 to 10 mass %, more preferably from 0.5 to 2 mass %, per 100 parts by mass of cellulose acylate, whereby the wavelength dispersion of Rth of the optical film can be adjusted. In view of coloration of the visible part or the value of |Rth(700)−Rth(400|, the amount added is preferably in the range above.

The cellulose acylate film, polarizing plate and liquid crystal display device of the present invention are described in sequence each by referring to one embodiment.

### 1. Cellulose Acylate Film

The cellulose acylate film of the present invention is suitable mainly as a protective film of polarizer or a support of optically-compensatory film.

The physical properties required of the protective film of polarizer are transparency, low optical anisotropy and appropriate rigidity. The transmittance is preferably 80% or more, more preferably 87% or more. The haze is preferably 2.0% or less, more preferably 1.0% or less. The refractive index is preferably from 1.4 to 1.7.

The transmittance and haze can be measured according to JIS K-6714 by using a haze meter (HGM-2DP, manufactured by Suga Test Instruments Co., Ltd.).

The refractive index can be measured using an Abbe refractometer (NAR-1T, manufactured by ATAGO K.K.).

As for the cellulose acylate film of the present invention, specifically, the cellulose acylate described in JIII Journal of Technical Disclosure, No. 2001-1745 is preferably used.

As for the raw material cotton of the cellulose acylate for use in the present invention, known raw materials described, for example, in JIII Journal of Technical Disclosure, No. 2001-1745 can be used. Also, the cellulose acylate material can be synthesized by a known method described, for example, in Migita et al., Mokuzai Kagaku (Wood Chemistry), pp. 180-190, Kyoritsu Shuppan (1968). The viscosity average polymerization degree of the cellulose acylate is preferably from 200 to 700, more preferably from 250 to 500, and most preferably from 250 to 350.

The viscosity average polymerization degree can be measured according to the intrinsic viscosity method proposed by Uda et al. (Kazuo Uda and Hideo Saito, Journal of the Society of Fiber Science and Technology, Japan, Vol. 18, No. 1, pp. 105-120 (1962)). The measuring method of the viscosity average polymerization degree is also described in JP-A-9-95538.

The acyl group of the cellulose acylate is not particularly limited but is preferably an acyl group having a carbon number of 2 to 4. An acetyl group and a propionyl group are preferred, and an acetyl group is more preferred. The total acyl group substitution degree is preferably from 2.7 to 3.0, more preferably from 2.8 to 2.95. In the case of using a cellulose acetate where all acyl groups are an acetyl group, the acetyl substitution degree is preferably from 2.7 to 2.95, more preferably from 2.8 to 2.95, and most preferably from 2.84 to 2.92. Also, from the standpoint that fluctuation of Re and Rth less occurs, the substitution degree by an acyl group at the 6-position is preferably 0.9 or more. The acyl group substitution degree employed in the present invention is a value calculated according to ASTM D817.

The glass transition temperature of the cellulose acylate film of the present invention is preferably from 100° C. to less than 160° C., more preferably from 120° C. to less than 155° C. The glass transition temperature can be measured by DSC or from the temperature dispersion of dynamic viscoelasticity.

In the optical film of the present invention, the Re value at a wavelength of 630 nm is from 0 to 20 nm, preferably 10 nm or less, more preferably 3 nm or less, and the Rth value at a wavelength of 630 nm is 10 nm or less, preferably from −20 to 10 nm, more preferably from −10 to 5 nm.

The cellulose acylate film of the present invention is preferably produced by a solvent casting method. In view of reducing the fluctuation of Re and Rth, the concentration of the cellulose acylate solution is preferably from 16 to 30 mass %, more preferably from 18 to 26 mass %. The organic solvent used is not particularly limited, but an organic solvent prepared by mixing a chlorine-based solvent, alcohols, ketones or esters is preferably used. The chlorine-based solvent is preferably methylene chloride or chloroform, the alcohol is preferably methanol, ethanol, 1-propanol, 2-propanol or 1-butanol, the esters is preferably methyl acetate, and the ketones is preferably acetone, cyclopentanone or cyclohexanone.

In the preparation of the cellulose acylate solution, the cellulose acylate is swelled by adding it to a solvent in a tank at room temperature while stirring the solvent. The swelling time is preferably 10 minutes or more, because no undissolved matter remains. The temperature of the solvent is preferably from 0 to 40° C. The temperature is preferably 0° C. or more because of no reduction in the swelling rate and no remaining of undissolved matters, and preferably 40° C. or less because of no occurrence of abrupt swelling and satisfactory swelling of the center portion. As for the method of dissolving cellulose acylate, either a cooling dissolution method or a high-temperature dissolution method or both may be used. As for the specific method regarding the cooling dissolution method and high-temperature dissolution method, a known method described, for example, in JIII Journal of Technical Disclosure, No. 2001-1745 may be used. It is also preferred depending on the case to prepare the cellulose acylate solution through dissolution to a low concentration and then concentration to an optimal concentration by using concentrating means.

In the process of preparing the dope, other additives according to usage can be added. Examples of the additive include an antioxidant, a peroxide decomposing agent, a radical inhibitor, a metal-inactivating agent, an acid scavenger, a deterioration inhibitor such as hindered amine, a releasing agent, and a matting agent (metal oxide fine particle).

As regards the method and apparatus for forming the cellulose acylate film of the present invention, the solution casting film formation method and solution casting film formation apparatus conventionally used for the production of cellulose triacetate film are used. The dope (cellulose acylate solution) prepared in a dissolving tank is once stored in a stock tank and finalized by removing the bubbles contained in the dope. The dope is fed to a pressure-type die from the dope discharge port through a pressure-type quantitative gear pump capable of feeding a liquid in a constant amount with high precision and uniformly cast on an endlessly running metal support (band or drum) in the casting part from a mouth ring (slit) of the pressure-type die, and the damp-dry dope film (also called web) is separated from the metal support. The obtained web is gripped by clips at both ends, conveyed by a tenter while keeping the width, thereby dried, then conveyed by a roll group of a drying apparatus to complete the drying, and taken up to a predetermined length by a take-up machine. The combination of the tenter and the drying apparatus comprising a roll group, the temperature of each member, and the residual solvent amount at respective points can be varied according to the purpose.

In the present invention, the film can be stretched by expanding the width at the tenter outlet wider than that at the tenter inlet so as to obtain the desired Re. The stretch ratio varies depending on the desired Re but is preferably from 1.0 to 1.3 times, more preferably from 1.0 to 1.25 times. The residual solvent amount of the film at the stretching is preferably from 2 to 35 mass %, more preferably from 2 to 30 mass %. The residual solvent amount is preferably 2 mass % or more in that the film is free from pulling or wrinkling and is not ruptured and satisfactory stretching effect is obtained, and is preferably 30 mass % or less in that the Re can be adjusted. In order to adjust the Re, the tension at the conveyance may be adjusted within the range of not causing a problem in the handling.

In the present invention, the cellulose acylate solution is preferably cast on a smooth band or drum working as the metal support so as to reduce the fluctuation of film thickness and in turn the fluctuation of optical anisotropy, but a plurality of cellulose acylate solutions may be co-cast.

In the production of the cellulose acylate film of the present invention, the dope on the metal support is preferably dried at 30 to 250° C., more preferably at 40 to 180° C., and most preferably at 40 to 140° C.

The thickness of the finished (dried) cellulose acylate film of the present invention is preferably from 20 to 100 μm, more preferably from 20 to 80 μm, and most preferably from 30 to 80 μm. The film thickness may be adjusted by controlling the concentration of solid contents contained in dope, the slit gap of die base, the extrusion pressure from die, the metal support speed or the like. In the case of using a triacetyl cellulose film having a thickness of 50 μm, it is preferred to use a triacetyl cellulose film described in JP-A-2002-022961 where the elongation at break (under the condition of 23° C./60% RH) in the MD direction is 0.75% or less.

It is also preferred to use a triacetyl cellulose film where the Ca, Fe and Mg contents in the cellulose acylate film are in the ranges described in JP-A-12-313766 or the ratio between the maximum peak strength near 1,488 cm⁻¹ and the maximum peak strength near 1,365 cm⁻¹, as determined by the ATR analysis on both surfaces of the film, is in the range described in JP-A-2002-258049.

### (Polarizing Plate)

The cellulose acylate film of the present invention is preferably used as a protective film of a polarizing plate. The polarizing plate in general is composed of a polarizer and two transparent protective films disposed on both sides of the polarizer. The cellulose acylate film of the present invention can be used as at least one protective film. The other protective film may be a normal cellulose acetate film. The polarizer includes an iodine-based polarizer, a dye-based polarizer using a dichromatic dye, and a polyene-based polarizer. The iodine-based polarizer and dye-based polarizer are generally produced using a polyvinyl alcohol-based film. In the case of using the cellulose acylate film of the present invention as a polarizing plate protective film, the polarizing plate is not particularly limited in its production method and can be produced by a general method. There is known a method where the cellulose acylate film obtained or a normal cellulose acetate film is alkali-treated and laminated using an aqueous solution of completely saponified polyvinyl alcohol on both surfaces or one surface of a polarizer produced by dipping a polyvinyl alcohol film in an iodine solution and stretching it. Instead of the alkali treatment, a process for easy adhesion described in JP-A-6-94915 and JP-A-6-118232 may be applied. Examples of the adhesive used for laminating the treated surface of the protective film to the polarizer include a polyvinyl alcohol-based adhesive such as polyvinyl alcohol and polyvinyl butyral, and a vinyl-based latex such as butyl acrylate.

The cellulose acylate film of the present invention is preferably laminated on the polarizer such that the absorption axis of the polarizer agrees with the longitudinal direction of the cellulose acylate film of the present invention, because the film can be continuously produced.

### (Optically-Compensatory Film)

An optically-compensatory layer may also be provided on one surface of the cellulose acylate film of the present invention. The optically-compensatory layer preferably has an orientation layer and an optically anisotropic layer in this order.

The orientation layer can be provided by a technique such as rubbing of an organic compound (preferably a polymer), oblique vapor deposition of an inorganic compound, or formation of a layer having microgrooves. An orientation layer which exhibits an orienting function as a result of application of an electric field or a magnetic field or irradiation with light is also known. In particular, the orientation layer is preferably formed by the rubbing of a polymer. The rubbing treatment is preferably performed by rubbing the polymer layer surface with paper or fabric several times in a definite direction. It is preferred that the absorption axis direction of the polarizer and the rubbing direction are substantially parallel. As regards the kind of the polymer used for the orientation layer, for example, a polyimide, a polyvinyl alcohol, or a polymerizable group-containing polymer described in JP-A-9-152509 may be preferably used. The thickness of the orientation layer is preferably from 0.01 to 5 μm, more preferably from 0.05 to 2 μm.

The optically anisotropic layer preferably contains a liquid crystalline compound. The liquid crystalline compound for use in the present invention is preferably a discotic compound (discotic liquid crystal) or a rod-like liquid crystalline compound.

### (Discotic Liquid Crystalline Compound)

Examples of the discotic liquid crystalline compound usable in the present invention include the compounds described in various publications (e.g., C. Destrade et al., Mol. Crysr. Liq. Cryst., Vol. 71, page 111 (1981); Kikan Kagaku Sosetsu (Quarterly Chemistry Survey), No. 22, “Ekisho no Kagaku (The Chemistry of Liquid Crystal)”, Chapter 5 and Chapter 10, Section 2, Nippon Kagaku Kai (compiler) (1994); B. Kohne et al., Angnew. Chem. Soc. Chem. Comm., page 1794 (1985); J. Zhang et al., J. Am. Chem. Soc., Vol. 116, page 2655 (1994)). The discotic liquid crystal molecule has a structure such that as in a triphenylene derivative, a discotic core part is present and side chains are radially extending therefrom. It is also preferred for imparting aging stability to further introduce a group capable of reacting under the action of heat, light or the like. Preferred examples of the discotic liquid crystal include those described in JP-A-8-50206.

### (Rod-Like Liquid Crystalline Compound)

Examples of the rod-like liquid crystalline compound which can be used in the present invention include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles. Not only these low molecular liquid crystalline compounds but also a polymer liquid crystalline compound can be used.

The discotic liquid crystal molecules in the vicinity of the orientation layer are aligned nearly in parallel to the film plane by making a pretilt angle in the rubbing direction, and the discotic liquid crystal molecules on the opposite air surface side are aligned upright in the form almost vertical to the surface. The discotic liquid crystal layer as a whole takes a hybrid alignment and by virtue of this layer structure, enlargement of a viewing angle of TN-mode TFT-LCD can be realized.

The optically anisotropic layer is generally obtained by coating on an orientation layer a solution containing a liquid crystal compound and other compounds (further containing, for example, a polymerizable monomer and a photopolymerization initiator) dissolved in a solvent, drying the solution, heating the coating to a nematic phase-forming temperature, effecting polymerization by the UV light irradiation or the like, and cooling the polymer layer.

The optically anisotropic layer may also be a non-liquid crystalline polymer layer produced by dissolving a non-liquid crystalline compound in a solvent, coating the solution on a support, and drying the coating. In this case, the non-liquid crystalline compound may be a polymer such as polyamide, polyimide, polyester, polyether ketone, polyaryl ether ketone, polyamidoimide and polyesterimide, because the polymer is excellent in the heat resistance, chemical resistance and transparency and rich in the rigidity. One of these polymers may be used alone, or a mixture of two or more kinds of polymers having different functional groups, for example, a mixture of polyaryl ether ketone and polyamide, may be used. Among these polymers, imide is preferred because of its high transparency, high aligning property and high stretching property. The support is preferably a TAC film.

It is also preferred that a laminate of non-liquid crystal layer and support is transversely stretched to 1.05 times by a tenter and the support side is laminated to a polarizer.

The optically anisotropic layer may be an alignment-fixed layer of cholesteric liquid crystal having selective reflection in the wavelength region of 350 nm or less. Examples of the cholesteric liquid crystal include those described in JP-A-3-67219, JP-A-3-140921, JP-A-5-61039, JP-A-6-186534 and JP-A-9-133810, and an appropriate compound exhibiting the selective reflection above may be selected therefrom and used. In view of stability and the like of the alignment-fixed layer, preferred are those capable of forming a cholesteric liquid crystal layer comprising, for example, a cholesteric liquid crystal polymer, a chiral agent-containing nematic liquid crystal polymer, or a compound which forms such a liquid crystal polymer by polymerization under light, heat or the like.

The optically anisotropic layer here can be formed, for example, by a method of coating the cholesteric liquid crystal on a support substrate. In this case, a system of recoating the same or different cholesteric liquid crystals according the purpose such as control of phase difference may be employed, if desired. For the coating treatment, an appropriate system such as gravure system, die system or dipping system may be employed.

At the formation of the optically anisotropic layer, means for orienting the liquid crystal is taken. The orienting means is not particularly limited and appropriate means capable of orienting the liquid crystal compound may be employed. Examples thereof include a system of coating the liquid crystal on an orientation film. Examples of the orientation film include a rubbing-treated film comprising an organic compound such as polymer, a film having thereon an obliquely vapor-deposited inorganic compound, a film having microgrooves, and a film where an LB film by the Langmure-Blogette method using an organic compound such as ω-tricosanoic acid, dioctadecylmethylammonium chloride or methyl stearate is accumulated. Furthermore, an orientation film of which orienting function is produced by the irradiation of light, may also be used. On the other hand, for example, a system of coating and orienting the liquid crystal on a stretched film (see, JP-A-3-9325), and a method of orienting the liquid crystal under application of an electric field, a magnetic field or the like, may also be employed. The aligned state of the liquid crystal is preferably uniform as much as possible, and a solidified layer fixed in that aligned state is preferred.

Such an optically-compensatory film may also be used as one surface of the above-described polarizing plate protective film having a polarizer on the opposite side to the side where the optically-compensatory layer is provided.

The produced polarizing plate is used by laminating it to a liquid crystal cell of a liquid crystal display device through a pressure-sensitive adhesive or the like. The cellulose acylate film of the present invention is preferably disposed as a protective film on the liquid crystal cell side of the polarizing plate.

The polarizing plate can be used on both sides or one side of a liquid crystal cell, and polarizing plates differing in the optical property may also be used in combination.

The cellulose acylate film of the present invention having small optical anisotropy is preferably used particularly for an IPS-mode liquid crystal cell and is preferably disposed on both sides of the liquid crystal cell. The cellulose acylate film having provided thereon an optically-compensatory layer is used for the VA mode or OCB mode.

### EXAMPLES

The present invention is described in greater detail below by referring to Examples. The materials, reagents, the amount and ratio of a substance, the operation and the like used in the following Examples can be appropriately changed without departing from the purport of the present invention. Accordingly, the scope of the present invention is not limited to the following specific examples.

### Example 1

### (Preparation of Cellulose Acylate Solution)

Cellulose acylate solutions are prepared using various cellulose acylates shown in Table 1 by charging the following composition into a mixing tank and stirring it to dissolve respective components.

### (Composition of Cellulose Acylate Solution)

| | |
|---|---|
| Cellulose acylate | 100.0 parts by mass |
| Methylene chloride (first solvent) | 400.0 parts by mass |
| Methanol (second solvent) | 60.0 parts by mass |

As for the compound which decreases the optical anisotropy, the plasticizer, and the wavelength-dispersion adjusting agent, those shown in Table 1 below are prepared each to give the amount added shown in Table 1, charged into a mixing tank and stirred to dissolve respective components. The resulting solution is mixed with the cellulose acylate solution above, and the mixed solution is further adjusted to a solid content concentration of 20 mass % and used as a dope.

### (Production of Transparent Film Using Cellulose Acylate Dope)

The cellulose acylate dope prepared above is filtered and then cast using a band casting machine. The film with a residual solvent amount of 30% is separated from the band, stretched by a tender, dried at 140° C. to reduce the residual solvent amount to 0.2 mass % or less, cooled and taken up to produce Comparative Samples 101, 102, 104, 106, 108 to 110, 112 and 113 and Transparent Film Samples 103, 105, 107, 111 and 114 of the present invention. The thickness of the produced film is finally from 78 to 82 μm.

Examples 115 and 114 are produced by adjusting the casting amount to give a final film thickness of 42 μm with the same contents.

TABLE 1

| | | | | Optical Anisotropy | | | | | | Wavelength-Dispersion | |
|---|---|---|---|---|---|---|---|---|---|---|---|
| | | | | Decreasing Agent | | | Plasticizer | | | Adjusting Agent | |
| Ex | Cellulose Acylate | | | | | Amount | | | Amount | | Amount |
| am- | Compo- | Substitution | 6% | | Molecular | Added | | | Added | | Added |
| ple | sition | Degree | Viscosity | | Weight | (mass %) | | | (mass %) | | (mass %) |
| | | | | | | | | Molecular | | | |
| | | | | | | | | Weight | | | |
| 101 | cellulose | 2.86 | 305 | — | — | 0 | TPP + BDP | 326, 403 | 12 | triazole derivative | 1.2 |
| 102 | acetate | | | PSt | 5500 | 10 | — | — | — | — | — |
| 103 | | | | | | 10 | TPP + BDP | 326, 403 | 12 | triazole derivative | 1.2 |
| 104 | | | | | | 20 | — | — | 0 | benzophenone | 1.0 |
| 105 | | | | | | 20 | ethylphthalyl | 280 | 10 | derivative | 1.0 |
| | | | | | | | ethyl glycolate | | | | |
| 106 | | | | PMMA | 10000 | 20 | — | — | — | triazole derivative | 1.2 |
| 107 | | | | | | 20 | UMM-1001 | 1000 | 10 | | 1.2 |
| 108 | | 2.92 | 380 | PMMA | 10000 | 0 | — | — | 0 | — | — |
| 109 | | | | | | 10 | — | — | 0 | triazine derivative | 1.0 |
| 110 | | | | | | 10 | UP-1010 | 1700 | 10 | — | — |
| 111 | | | | | | 10 | | | | triazine derivative | 1.0 |
| 112 | | | | | 20500 | 20 | — | — | | — | — |
| 113 | | | | | | 20 | UMM-1001 | 1000 | 10 | — | — |
| 114 | | | | | | 20 | | | | triazine derivative | 1.2 |

| | | |
|---|---|---|
| | Mw | |
| UP-1010 | 1700 | ARUFUN, produced by Toagosei |
| | | Co., Ltd. |
| UMM-1001 | about | ACTFLOW, produced by The Soken |
| | 1000 | Chemical & Engineering Co., Ltd. |

In Table 1, PSt denotes polystyrene, PMMA denotes polymethyl methacrylate, TPP denotes triphenyl phosphate, and BDP denotes biphenyl diphenyl phosphate.

As for the wavelength-dispersion adjusting agent in Table 1, compounds having the following structures are used.

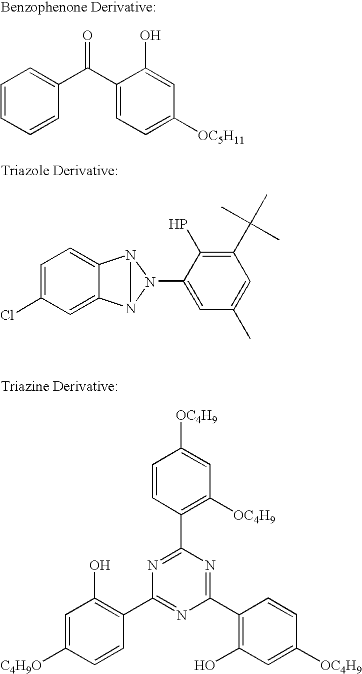

### (1-11) Evaluations and Results

### (1) Transparency and Bleed-Out Property of Film

The haze value and transparency are measured and evaluated using a haze meter and a transmittance meter, respectively.

### (2) Optical Properties of Film

In the present invention, Re(λ) and Rth(λ) indicate the in-plane retardation and the retardation in a thickness-direction, respectively, at a wavelength of λ. Re(λ) is measured by making light at a wavelength of λ nm to be incident in the film normal direction in KOBRA 21ADH or WR (manufactured by Oji Scientific Instruments).

In the case where the film measured is a film expressed by a uniaxial or biaxial refractive index ellipsoid, the Rth(λ) is calculated by the following method.

The above-described Re(λ) is measured at 6 points in total by making light at a wavelength of λ nm to be incident from directions inclined with respect to the film normal direction in 10° steps up to 50° on one side from the normal direction with the inclination axis (rotation axis) being the in-plane slow axis (judged by KOBRA 21ADH or WR) (when the slow axis is not present, an arbitrary direction in the film plane is used as the rotation axis) and based on the retardation values measured, the assumed values of average refractive index and the film thickness values input, Rth(λ) is calculated by KOBRA 21ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21ADH or WR after converting its sign into a negative sign.

Incidentally, after measuring the retardation values from two arbitrary inclined directions by using the slow axis as the inclination axis (rotation axis) (when the slow axis is not present, an arbitrary direction in the film plane is used as the rotation axis), based on the values obtained, the assumed values of average refractive index and the film thickness values input, Rth can also be calculated according to the following formulae (1) and (2).

$$Re ( θ ) = [ n x - \frac{n y \times n z}{\sqrt{\begin{matrix}{\{ n y sin ( {sin}^{- 1} ( \frac{sin ( - θ )}{n x} ) ) \}}^{2} + \\ {\{ n z cos ( {sin}^{- 1} ( \frac{sin ( - θ )}{n x} ) ) \}}^{2}\end{matrix}}} ] \times \frac{d}{cos \{ {sin}^{- 1} ( \frac{sin ( - θ )}{n x} ) \}} \qquad Formula ( 1 )$$

### Note:

Re(θ) above represents the retardation value in the direction inclined at an angle of θ from the normal direction.

In formula (1), nx represents the refractive index in the in-plane slow axis direction, ny represents the refractive index in the direction crossing with nx at right angles in the plane, nz represents the refractive index in the direction crossing with nx and ny at right angles, and d represents the thickness of the film.

Rth=((nx+ny)/2−nz)xd Formula (2)

In the case where the film measured is a film incapable of being represented by a uniaxial or biaxial refractive index ellipsoid or a film not having a so-called optic axis, Rth(λ) is calculated by the following method.

The Re(λ) is measured at 11 points by making light at a wavelength of λ0 nm to be incident from directions inclined with respect the film normal direction in 10° steps from −50° to +50° with the inclination axis (rotation axis) being the in-plane slow axis (judged by KOBRA 21ADH or WR) and based on the retardation values measured, the assumed values of average refractive index and the film thickness values input, Rth(λ) is calculated by KOBRA 21ADH or WR.

In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

ΔRth is defined by the following formula:

ΔRth=|Rth(700)−Rth(400)| Formula (3)

### (3) Glass Transition Temperature (Tg) of Film

A film sample of 5 mm×30 mm is moisture-conditioned at 25° C.-60% RH for 2 hours or more and then measured by a dynamic viscoelasticity meter (DVA-225 (manufactured by IT Keisoku Seigyo K.K.)) under the conditions of a gripping distance of 20 mm, a temperature rising rate of 2° C./min and a frequency of 1 Hz, and the temperature at the intersection between a straight line extending from low temperature side to high temperature side in the temperature dependency curve of the dynamic storage modulus and a tangent line as the gradient in the straight line portion after the dynamic storage modulus abruptly decreases is determined as the glass transition temperature.

### (4) Haze of Film

As for the measurement of haze, the cellulose acylate film of the present invention is measured according to JIS K-6714 by using a haze meter (HGM-2DP, manufactured by Suga Test Instruments Co., Ltd.) at 25° C. and 60% RH.

### (5) Evaluation of Brittleness

Five sheets of the film sample are superposed on a rubber-made mat of 18 cm×16 cm of a Thomson punching machine and punched, the length of a longest crack out of cracks extending from four corners toward the inner side is measured, and the brittleness is evaluated by the suitability for punching. The brittleness is rated A when the longest crack length is 2 mm or less, and rated B when 3 mm or more.

TABLE 2

| | Re | Rth | ΔRth | Tg | Haze | |
|---|---|---|---|---|---|---|
| Example | (nm) | | | ° C. | % | Brittleness |
| 101 | 3.1 | 40.0 | 35 | 145 | 0.2 | A |
| 102 | 2.5 | 8.8 | 36 | 160 | 1.0 | B |
| 103 | 2.0 | 5.0 | 20 | 148 | 0.4 | A |
| 104 | 0.8 | −3.2 | 31 | 165 | 4.3 | B |
| 105 | 0.5 | −2.0 | 20 | 150 | 0.4 | A |
| 106 | 0.6 | −6.2 | 22 | 115 | 1.5 | B |
| 107 | 0.8 | −5.0 | 25 | 155 | 0.5 | A |
| 108 | 1.2 | 8.0 | 45 | 185 | 0.9 | B |
| 109 | 1.0 | −8.0 | 25 | 181 | 1.1 | B |
| 110 | 0.6 | −9.6 | 30 | 155 | 0.4 | A |
| 111 | 0.8 | −2.0 | 20 | 152 | 0.3 | A |
| 112 | 0.4 | −5.0 | 28 | 176 | 2.2 | B |
| 113 | 0.8 | −10.0 | 32 | 150 | 0.5 | A |
| 114 | 1.0 | −8.2 | 15 | 145 | 0.4 | A |
| 115 | 0.6 | −5.0 | 8 | 145 | 0.3 | A |

B: 3 mm or more,
A: 2 mm or less.

As seen from Table 2, in the cellulose acylate film of the present invention, the optical uniformity is satisfied, Tg is not too high and the handling property is good (non-brittle and flexible).

### Example 2

Polarizing plates and liquid crystal display devices are produced using Samples 101, 105, 114 and 115 as the protective film (see, the Drawing). More specifically, an upper polarizing plate (protective film: H1, polarizer: P1, protective film: A1), a liquid crystal cell (phase difference film A: L1, liquid crystal layer: L2, phase difference film B: L3), and a lower polarizing plate (protective film: A2, polarizer: P2, protective film: H2) are stacked from the viewing direction (top), and a backlight source (not shown) is further disposed.

### <Protective Films H1 and H2>

A commercially available cellulose acetate film (FUJI-TAC TD80UF, produced by Fuji Photo Film Co., Ltd.) is used as Protective Films H1 and H2.

### <Polarizing Film>

A polarizing film is produced by adsorbing iodine to a stretch polyvinyl alcohol film and employed.

### (Production of Polarizing Plate)

Transparent Film Samples 101, 105, 114 and 115 each is dipped in an aqueous 1.5 N sodium hydroxide solution at 55° C. for 2 minutes, washed in a water-washing bath at room temperature, and neutralized using 0.1 N sulfuric acid at 30° C. The film is again washed in a water-washing bath at room temperature and then dried with hot air at 100° C.

Subsequently, a 80 μm-thick polyvinyl alcohol film in a roll form is continuously stretched to 5 times in an aqueous iodine solution and dried to obtain a polarizing film having a thickness of 20 μm, and the alkali-saponified transparent film sample and protective film above are laminated with the intervention of the polarizing film therebetween by using an aqueous 3% polyvinyl alcohol (PVA-117H, produced by Kuraray Co., Ltd.) solution as the adhesive, whereby a polarizing plate is produced.

### <Production of IPS-Mode Liquid Crystal Cell>

Electrodes are provided on one glass substrate such that the distance between adjacent electrodes becomes 20 μm, and a polyimide film is provided thereon as an orientation film and subjected to a rubbing treatment. Separately, one glass substrate is prepared, and a polyimide film is provided on one surface thereof and subjected to a rubbing treatment to serve as an orientation film. These two glass substrates are superposed and laminated such that the orientation films face each other with a gap (d₁) of 3.9 μm between substrates and the rubbing directions of two glass substrates run in parallel. Subsequently, a nematic liquid crystal composition having a refractive index anisotropy (Δn) of 0.0769 and a positive dielectric constant anisotropy (Δε) of 4.5 is encapsulated in the gap. The d₁Δn value of the liquid crystal layer is 300 nm.

### (Liquid Crystal Display Device)

The polarizing plate produced is stacked on both sides of the IPS-mode liquid crystal cell with a pressure-sensitive adhesive by disposing the film of the present invention on the liquid crystal cell side. The polarizing plate on the viewing side is stacked so that the abnormal light refractive index direction of the liquid crystal composition in the liquid crystal cell and the absorption axis of the polarizing plate can cross at right angles at the time of not applying a voltage. Also, the absorption axis of the polarizing plate on the backlight side is disposed to cross with the absorption axis of the polarizing plate on the viewing side at right angles.

### (Evaluation)

The leaked light and tint change in the 45° oblique direction at black display of this IPS panel are observed. In the display devices using 105 or 112 for the protective film A1, it can be confirmed at a glance that the leaked light and tint change when obliquely viewed are small as compared with the display device using 101. This is an effect by virtue of small Re and Rth values of the protective film.

The entire disclosure of each and every foreign patent application from which the benefit of foreign priority has been claimed in the present application is incorporated herein by reference, as if fully set forth.

What is claimed is:

1. An optical film comprising:
a cellulose acylate;
a polymer additive that decreases an optical anisotropy of the cellulose acylate;
a compound that has a plasticizing effect; and
a compound that changes a wavelength dispersion of an optical property of the cellulose acylate.

2. The optical film according to claim 1,
wherein the polymer additives has an average molecular weight of 3,000 or more, and
the compound having the plasticizing effect has a molecular weight of 3,000 or less.

3. The optical film according to claim 1,
wherein the compound changing the wavelength dispersion of the optical property is a compound that absorbs a light in the ultraviolet region.

4. The optical film according to claim 1,
wherein an acyl group of the cellulose acylate has from 2 to 4 carbon atoms, and
a total substitution degree of the cellulose acylate is from 2.7 to 3.0.

5. The optical film according to claim 1, having a glass transition temperature of from 100° C. to less than 160° C.

6. The optical film according to claim 1, having Re(630) of 0 to 20 nm and Rth(630) of from −20 to 10 nm,
wherein Re(630) represents an in-plane retardation at a wavelength of 630 nm, and
Rth(630) represents a retardation in a thickness direction at a wavelength of 630 nm.

7. The optical film according to claim 1, satisfying the following formula (3):

|Rth(700)−Rth(400)|≦25 nm Formula (3)
wherein Rth(700) and Rth(400) represent retardations in a thickness direction at a wavelength of 700 nm and 400 nm, respectively.

8. A polarizing plate comprising:
a polarizer; and
the optical film according to claim 1, which is provided on at least one side of the polarizer.

9. A liquid crystal display device comprising:
the polarizing plate according to claim 8.
